(19) United States
(12) Patent Application Publication
(10) Pub. No.: US 2026/0341157 A1
(43) Pub. Date: Oct. 29, 2026

(54) ELECTRONIC DEVICE AND VEHICLE SPEED SYNCHRONIZATION METHOD THEREFOR

(71) Applicant: INAVI SYSTEMS CORPORATION, Seongnam-si, Gyeonggi-do (KR)

(72) Inventor: Da El CHOI, Gunpo-si (KR)

(73) Assignee: INAVI SYSTEMS CORPORATION, Seongnam-si, Gyeonggi-do (KR)

(21) Appl. No.: 19/102,594

(22) PCT Filed: Aug. 8, 2023
(86) PCT No.: PCT/KR2023/011675

§ 371 Date: Feb. 10, 2025

(30) Foreign Application Priority Data
Aug. 8, 2022 (KR) 10-2022-0098514
Aug. 8, 2023 (KR) 10-2023-0103373

(51) Int. Cl. G08G 1/00; G08G 1/01; G08G 1/052; G08G 1/0967; H04W 4/46

(52) U.S. Cl. CPC G08G 1/22; G08G 1/0141; G08G 1/0145; G08G 1/052; G08G 1/096725; H04W 4/46

(57) ABSTRACT

An electronic device according to one embodiment disclosed in the present document comprises: a communication module for providing communication channels for a plurality of vehicles; and a processor functionally connected to the communication module, wherein the processor can obtain a plurality of pieces of vehicle position information from the plurality of vehicles through the communication module, group, on the basis of the plurality of pieces of vehicle position information, vehicles driving in the same lane on the same road from among the plurality of vehicles, obtain speed information about a lead vehicle in each group through the communication module, and provide speed information about the lead vehicle to the vehicles in each group through the communication module so that speed control of the vehicles in each group is synchronized.

### TECHNICAL FIELD

This research was conducted as part of Innovation Project for Autonomous Driving Technology Development (20014361) supported by Ministry of Trade, Industry and Energy and Korea Evaluation Institute of Industrial Technology.

Various embodiments disclosed in this document are related to an inter-vehicle speed sharing technology.

### BACKGROUND ART

A traffic jam is a phenomenon which may be often found in places where the volume of traffic is great. One of the traffic jams is a change in the speed (acceleration and deceleration) of a vehicle attributable to a change in the traffic situation. For example, a traffic jam phenomenon according to a change in the speed of a vehicle attributable to a change in the traffic situation includes a ghost or moving bottleneck phenomenon.

FIG. 1 is a diagram for describing a ghost jam which Causes a conventional traffic jam phenomenon. FIG. 2 is a diagram for describing a moving bottleneck phenomenon which causes a conventional traffic jam phenomenon.

According to the ghost jam, when a vehicle in an adjacent lane cuts in front of one vehicle, a delay time occurs because the one vehicle has to reduce the speed of the one vehicle by determining a movement of a vehicle ahead of the one vehicle and stepping on the brake of the one vehicle. Delay times occur because each of vehicles behind the one vehicle also has to determine a movement of a vehicle ahead of each vehicle and reduce the speed of each vehicle. Since such a delay time is accumulated as it goes to a vehicle behind, the vehicle becomes slower and slower as it goes to the vehicle behind, and eventually the vehicle may stop.

For example, the ghost jam is described as follows with reference to FIG. 1.
A No. 0 vehicle changes its lane.
The speed of a No. 1 vehicle is changed. At this time, a delay time occurs because the No. 1 vehicle is decelerated after determining a change in the lane of the No. 0 vehicle.
The speed of a No. 2 vehicle is changed. At this time, a delay time occurs because the No. 2 vehicle is decelerated after determining the deceleration of the No. 1 vehicle.
Vehicles behind the No. 3 vehicle experience a process similar to that of the No. 2 vehicle.

Referring to FIG. 2, the moving bottleneck phenomenon is a phenomenon in which one vehicle on a road hinders a flow of other vehicles because the one vehicle travels at a slower speed than other vehicles.

### DISCLOSURE

### Technical Problem

Delay time occurs during the process of checking and making a decision because the driver of a vehicle behind drives his or her vehicle after checking a control situation of a vehicle ahead with the naked eye and determining a driving behavior capable of preventing an accident. Accordingly, a traffic jam occurring due to a vehicle ahead is inevitably increased as it goes back.

Various embodiments disclosed in this document may provide an electronic device capable of the synchronization of vehicle speeds and a method of synchronizing the speeds of vehicles thereby.

### Technical Solution

An electronic device according to an embodiment disclosed in this document includes a communication module configured to provide a communication channel for a plurality of vehicles, and a processor functionally connected to the communication module. The processor may obtain a plurality of pieces of vehicle location information from the plurality of vehicles through the communication module, may group vehicles travelling in an identical lane of an identical road, among the plurality of vehicles, based on the plurality of pieces of vehicle location information, may obtain speed information of a leading vehicle within each group through the communication module, and may provide the speed information of the leading vehicle to vehicles within each group through the communication module so that speed control over the vehicles within each group is synchronized.

Furthermore, a method of synchronizing the speeds of vehicles by an electronic device according to an embodiment disclosed in this document may include an operation of obtaining a plurality of pieces of vehicle location information from a plurality of vehicles, an operation of grouping vehicles that are travelling in an identical lane of an identical road, among the plurality of vehicles, based on the plurality of pieces of vehicle location information, an operation of obtaining speed information of a leading vehicle in each group, and an operation of providing the speed information of the leading vehicle to vehicles within each group so that speed control over the vehicles within each group is synchronized.

### Advantageous Effects

According to various embodiments disclosed in this document, the speeds of vehicles that travel on a road can be synchronized. In addition, various effects which may be checked directly or indirectly through this document may be provided.

### BRIEF DESCRIPTION OF DRAWINGS

FIG. 1 is a diagram for describing a ghost jam which causes a conventional traffic jam phenomenon.

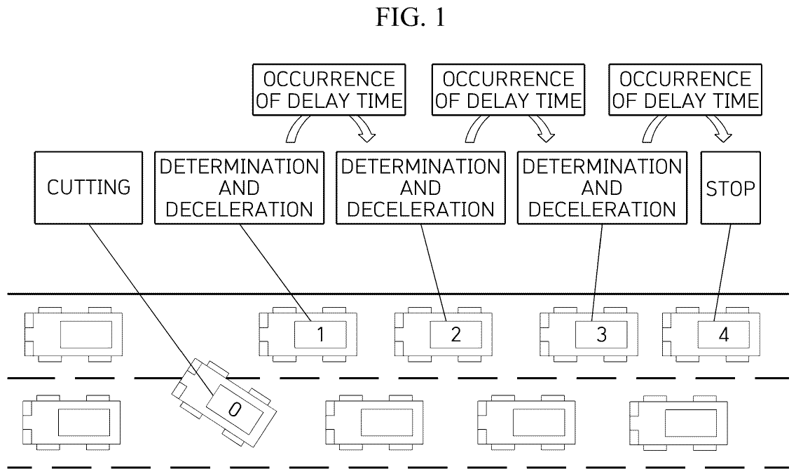

FIG. 2 is a diagram for describing a moving bottleneck phenomenon which causes a conventional traffic jam phenomenon.

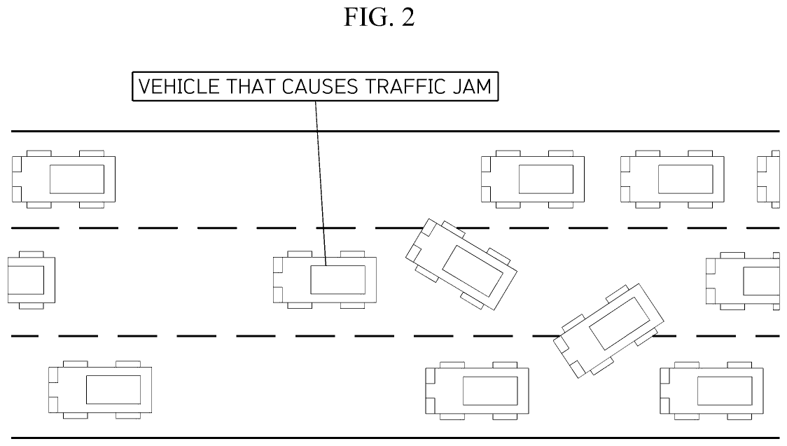

FIG. 3 is an environment in which an electronic device according to an embodiment is embodied.

FIG. 4 is a construction diagram of the electronic device according to an embodiment.

FIGS. 5 and 6 are examples in which the speeds of vehicles are synchronized according to an embodiment.

FIGS. 7 and 8 are examples in which vehicle groups are integrated or separated according to an embodiment.

FIG. 9 is an example in which a group is controlled in a lane change situation according to an embodiment.

FIG. 10 is a flowchart of a method of synchronizing the speeds of vehicles according to an embodiment.

FIG. 11 is a detailed flowchart 4 a method of synchronizing the speeds of vehicles according to an embodiment.

FIG. 12 is a construction diagram illustrating a vehicle system for embodying a speed sharing method according to an embodiment.

In relation to the description of the drawings, the same or similar reference numeral may be used for the same or similar component.

### MODE FOR INVENTION

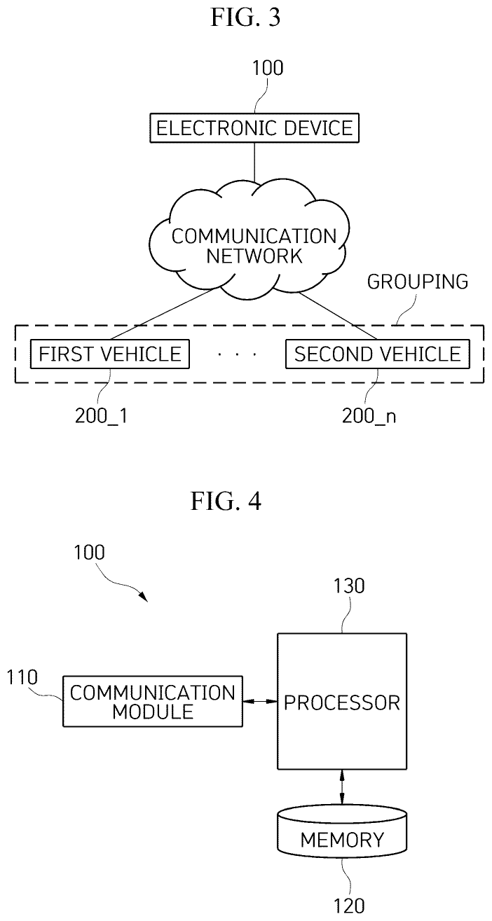

FIG. 3 is an environment in which an electronic device according to an embodiment is embodied.

Referring to FIG. 3, according to an embodiment, vehicles 200_1 to 200_N may each be a vehicle having a function that assists the driving of a driver, such as an autonomous vehicle. The vehicles 200_1 to 200_N may be provided to be capable of vehicle to everything (V2X) communication. For example, the vehicles 200_1 to 200_N may perform vehicle to infrastructure (V2I) communicate with an electronic device 100.

According to an embodiment, the electronic device 100 may be a business operator server that provides a vehicle speed synchronization service, for example. However, the present disclosure is not limited thereto.

According to an embodiment, the electronic device 100 may obtain vehicle location information of each vehicle from the vehicles 200_1 to 200_N through V2I communication. The vehicle location information may include vehicle identification information, a vehicle location coordinate value, a link ID, and a lane number.

According to an embodiment, the electronic device 100 may group vehicles that are traveling in the same (identical) lane of the same road, among a plurality of vehicles, based on a plurality of pieces of vehicle location information. In relation thereto, the electronic device 100 may confirm a vehicle that is traveling in the same lane of the same road based on a link ID and a road number included in vehicle location information.

According to an embodiment, the electronic device 100 may synchronize speed control over vehicles within a group by obtaining speed information of a leading vehicle 200_1 in each group and providing the obtained speed information to the vehicles 200_1 to N (N is a constant equal or greater than 2) within a group. The speed information may include at least piece of information, among a speed, acceleration, an accelerator state, or a brake state. The vehicle behind (e.g., 200_N) within the group may check the speed of leading vehicle and track the speed of the leading vehicle. Accordingly, the electronic device 100 according to an embodiment can reduce a driver's decision time and reduce a traffic jam attributable to the decision time because the electronic device can support vehicles on the same lane so that the vehicles move at the same speed and acceleration like a train.

According to an embodiment, when confirming that a vehicle (e.g., a vehicle disposed between the vehicles 200_1 to 200_N) within a group complies with a designated condition corresponding to a sudden speed change, the electronic device 100 may provide speed information of a vehicle behind to vehicles behind the corresponding vehicle. For example, the electronic device 100 may determine that a designated condition is satisfied in at least one of a case in which a travelling vehicle is suddenly decelerated, a case in which a travelling vehicle suddenly stops, or a case in which a lane change occurs in a travelling vehicle.

According to an embodiment, the electronic device 100 may separate, newly construct, or merge a group based on route information or vehicle location information. For example, when confirming a vehicle having a driving road or lane changed within each group, the electronic device 100 may exclude the confirmed vehicle from the corresponding group.

As described above, the electronic device 100 according to an embodiment can share a control state with respect to a vehicle that is travelling on the same lane. Accordingly, it is possible to reduce a decision-making time required to control the control state of a leading vehicle and determine how to drive. As a result, a traffic jam can be reduced.

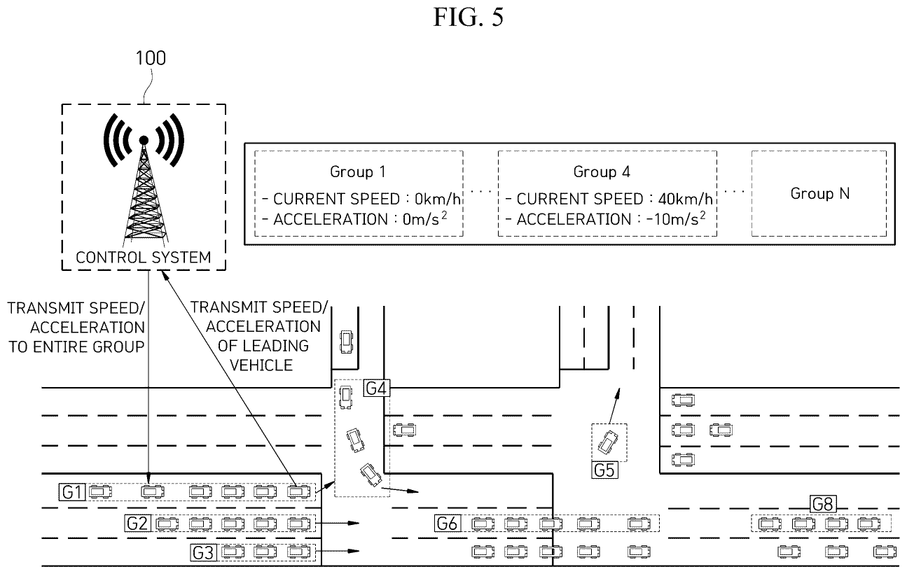

FIG. 4 is a construction diagram of the electronic device according to an embodiment.

Referring to FIG. 4, the electronic device 100 according to an embodiment may include a communication module 110, memory 120, and a processor 130. In an embodiment, some components of the electronic device 100 may be omitted or an additional component may be further included in the electronic device. For example, an input device (not illustrated) that receives a user input and an output device (not illustrated) that outputs an auditory or visual element may be further included. Furthermore, some of the components of the electronic device 100 may be combined into one entity, but may identically perform a function of corresponding components prior to the combination.

The communication module 110 may support the establishment of a communication channel or a wireless communication channel between the electronic device 100 and another apparatus (e.g., a vehicle) and the execution of communication through the established communication channel. The communication module 110 may be V2X communication, such as vehicle to vehicle (V2V) communication, vehicle to infrastructure (V2I) communication, vehicle to nomadic device (V2N) communication, or vehicle to pedestrian (V2P) communication, for example. The communication module 110 may communicate with vehicles (e.g., 200_1 to N) by adopting a known long-distance communication method, such as 3G, 4G, 5G, CDMA, GSM, W-CDMA, TD-SCDMA, WiBro, LTE, or EPC, for example. Alternatively, the communication module 110 may communicate with a vehicle V by adopting a short-distance communication method, such as a wireless LAN, Wi-Fi, Bluetooth, Zigbee, Wi-Fi Direct (WFD), an ultrawideband (UWB), infrared data association (IrDA), Bluetooth low energy (BLE), or near field communication (NFC).

The memory 120 may store various data that are used by at least one component (e. g., the processor 130) of the electronic device 100. The data may include software and input data or output data for a command related to the software, for example. For example, the memory 120 may store at least one instruction for providing a vehicle speed synchronization service.

The memory 120 may include various forms of volatile memory or nonvolatile memory. For example, the memory may include read only memory (ROM) and random access memory (RAM). In an embodiment of this specification, the memory may be disposed inside or outside the processor. The memory 120 may be connected to the processor 130 through various already-known means.

The processor 130 may control at least another component (e. g., hardware or software component) of the electronic device 100, and may perform various data processing or operations. The processor 130 may include at least one of a central processing unit (CPU), a graphic processing unit (GPU), a microphone processor, an application processor, an application specific integrated circuit (ASIC), or a field programmable gate array (FPGA), for example, and may have a plurality of cores.

According to an embodiment, the processor 130 may obtain a plurality of pieces of vehicle location information from a plurality of vehicles through the communication module 110. The vehicle location information may include at least piece of information, among vehicle identification information (ID), a vehicle location coordinate value, the link ID of a driving road of each vehicle, and the driving lane number of each vehicle. In relation thereto, the processor 130 may provide a vehicle speed synchronization service to pre-registered vehicles by receiving a plurality of pieces of vehicle location information from pre-registered vehicles.

According to an embodiment, the processor 130 may group vehicles that are travelling in the same (identical) lane of the same road, among vehicles, based on a plurality of pieces of vehicle location information. The processor 130 may confirm a link ID and a lane number in the vehicle location information, and may group vehicles having the same link ID and lane number.

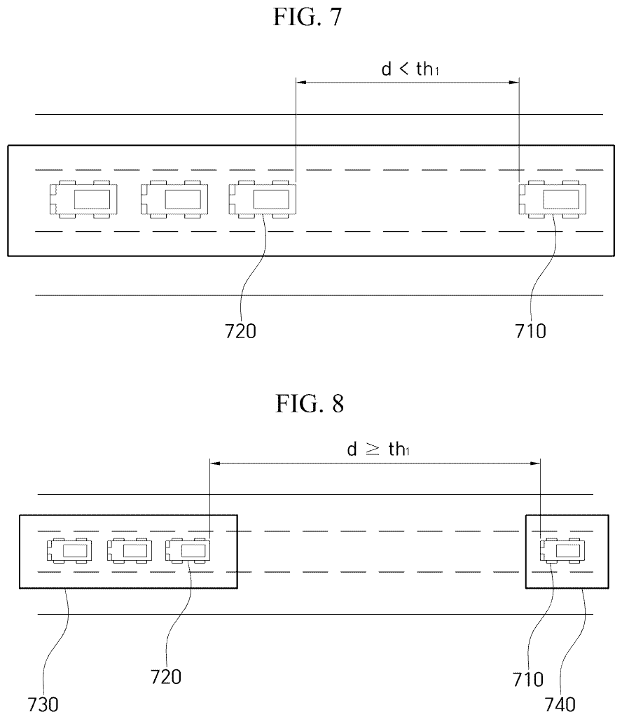

The processor 130 may group vehicles whose interval from a vehicle ahead is less than a first designated distance, among vehicles that are travelling in the same lane of the same road, as one group. The first designated distance is a reference distance that determines whether to control the speeds of vehicles that are travelling in the same lane by grouping the vehicles, and may be set as a common safety distance or more between vehicles. The first designated distance may be about 15 m, for example, which corresponds to a visible distance of a sensor included in each vehicle or a driver. The integration or separation of a group based on the first designated distance by the processor 130 is described later with reference to FIG. 7.

According to an embodiment, the processor 130 may check the driving sequence of each vehicle within a group based on a location coordinate value included in vehicle location information, and may sequentially assign turns (sequence numbers) to the vehicles within the t group according to the driving sequences. The processor 130 may mutually relate and store at least some (e. g., a driving road and a driving lane) that belongs to the vehicle location information, identification information of each vehicle, and the turns within the group in the memory 120. Thereafter, the processor 130 may distinguish a group to which each vehicle belongs, a leading vehicle and a vehicle behind, among the vehicles, and a control target vehicle within the group, based on group information and turn information related to the vehicle identification information. The processor 130 may provide (assign) the group information and the turn information to each vehicle, and may use the group information and the turn information only for the management of a group itself. The processor 130 may assign and allocate a turn again when there is a change in a vehicle within a group due to various causes, such as a lane change or the arrival of a destination.

According to an embodiment, the processor 130 may obtain speed information of a leading vehicle from the leading vehicle of each group by requesting the speed information from the leading vehicle of each group through the communication module 110. The speed information may include at least piece of information, among a speed, acceleration, an accelerator state, and a brake state.

According to an embodiment, the processor 130 may support that speed control over vehicles within each group is synchronized by providing the vehicles within each group with speed information of a leading vehicle of each group through the communication module 110. For example, the processor 130 may transmit at least piece of information, among a speed, acceleration, accelerator state, and brake state of a leading vehicle, to vehicles (e.g., 200_1 to N in FIG. 3) belonging to the same group.

Thereafter, when one (e.g., 200_1 in FIG. 3) of vehicles belonging to the same group is a leading vehicle, a vehicle behind the vehicle 200_1 may control their accelerators and acceleration pedals, ensuring that their speed and acceleration align with those of the leading vehicle, while maintaining a safety distance of the second designated distance or more from the vehicle ahead. The second designated distance may be set as a common safety distance, that is, the first designated distance or more The second designated distance may be 5 m, for example. The second designated distance may be set as a distance where a vehicle can simultaneously depart after checking the departure of a leading vehicle. The second designated distance may be identically set by all of vehicles of each group. In relation thereto, the processor 130 may share the second designated distance corresponding to the safety distance with vehicles within each group. The first designated distance and the second designated distance may be fixedly set, and may vary depending on a road state (e.g., a straight road, a curved road, or a section in which an accident often occurs), a weather state (upon raining), or traffic information (e. g., an average speed or a limited speed).

According to an embodiment, the processor 130 may obtain and monitor vehicle location information from vehicles within each group periodically or in synchronization with an event. For example, the processor 130 periodically obtains vehicle location information from a vehicle within each group, but may obtain vehicle location information separately from a designated cycle at timing at which an event, such as a change in a lane number or a link ID, occurs.

According to an embodiment, the processor 130 may check (monitor) whether a vehicle behind within a group complies with a designated condition corresponding to a sudden change in the speed based on vehicle location information obtained from each group. For example, the processor 130 may determine that a designated condition is satisfied in at least one of a case in which a corresponding vehicle behind is suddenly decelerated, a case in which a corresponding vehicle behind suddenly stops, or a case in which a lane change occurs in a corresponding vehicle behind.

When confirming a vehicle behind that complies with a designated condition, the processor 130 may provide speed information of the confirmed vehicle to a vehicle (a travelling vehicle behind the confirmed vehicle) having a later turn than the confirmed vehicle. In this case, vehicles behind that receive the speed information of the confirmed vehicle may perform sudden deceleration or a sudden stop based on the received speed information, or may perform avoidance control, such as a lane change.

According to an embodiment, when confirming an abnormal stop vehicle within a group based on vehicle location information, the processor 130 may reconstruct a target group on the basis of the confirmed stop vehicle. The abnormal stop vehicle may be a vehicle that has stopped in the state in which the abnormal stop vehicle has been spaced apart from a vehicle ahead thereof by a third designated distance or more due to a reason (e.g., a failure), other than waiting for signal or a stop for securing a safety distance, such as a traffic jam, for example. The third designated distance may be set to be greater than the second designated distance. In relation thereto, when confirming an abnormal stop state, the abnormal stop vehicle may transmit emergency situation information (e. g., accident type information) £ to the electronic device 100. In response thereto, the electronic device 100 may perform a follow-up action (e.g., call a tow truck) for coping with an accident of the abnormal stop vehicle.

For example, when confirming an abnormal stop vehicle, the processor 130 may transmit a lane change request to a vehicle behind the abnormal stop vehicle within a group through the communication module 110. The processor 130 checks whether another group is present in a lane next to the vehicle behind within the group, and may transmit a deceleration request to a vehicle behind the abnormal stop vehicle within the another group when the another group is present. In response thereto, a decelerated vehicle within the another group is present in response to the deceleration request. The vehicle behind within the group may cut into a space that is formed by the decelerated vehicle.

According to an embodiment, the processor 130 may obtain a lane change request for another lane from at least one vehicle within each group through the communication module 110. When obtaining the lane change request, the processor 130 may check whether another group previously constructed in another lane is present. When the another group is present in the another lane, the processor 130 may provide (e.g., transmit) a deceleration request to vehicles behind with respect to at least one vehicle within the another group. Thereafter, a vehicle within the another group, which has been decelerated in response to the deceleration request, is present. A vehicle that has made the lane change request may cut into a space that is formed by the decelerated vehicle.

According to an embodiment, when confirming a vehicle having a driving road and lane changed or a vehicle attempting to change a lane, compared to other vehicles, in each group based on vehicle location information, the processor 130 may exclude the confirmed vehicle from the corresponding group. For example, when confirming a vehicle separated from a vehicle ahead due to a traffic signal, among vehicles within each group, the processor 130 may separate the corresponding vehicle from a previous group. Thereafter, the processor 130 may group the corresponding vehicle with a vehicle behind the corresponding vehicle. As another example, the processor 130 may exclude a vehicle that has performed a lane change, among vehicles within each group, from a group of a previous lane, and may group the vehicle in a changed lane.

According to an embodiment, the processor 130 may further obtain route information from a plurality of vehicles through the communication module 110, and may differently construct a group depending on the route of each vehicle based on the route information. For example, the processor 130 may distinguish between a straight-forward vehicle and a left-turn (or right-turn) vehicle, among vehicles within a group, which are waiting for a signal in one lane where going straight and a left (or right) turn are possible, based on route information. The processor 130 may construct vehicles that go straight as a first group and construct vehicles that make a left (or right) turn as a second group, based on route information.

According to an embodiment, the processor 130 may further obtain traffic information (e.g., front traffic light information) from vehicles within each group through the communication module 110, and may provide vehicles within each group with at least some of the obtained traffic information. For example, the processor 130 may obtain traffic information from a leading vehicle within each group, and may provide the obtained traffic information to a vehicle behind within a group. In this case, the vehicle behind may predict driving control of the leading vehicle based on the traffic information.

As described above, the electronic device 100 according to an embodiment can reduce a traffic jam by reducing an unnecessary decision time because the electronic device synchronizes speeds and acceleration (and the second designated distance) so that all of vehicles in the same lane are synchronized like a train. Specifically, the electronic device 100 according to an embodiment can reduce a conventional traffic jam according to a change in the speed because the electronic device synchronizes the acceleration/deceleration of a vehicle behind by dynamically grouping and managing vehicles that are travelling in a same lane through V2X communication and sharing the speed of a leading vehicle within a group.

Furthermore, the electronic device 100 according to an embodiment can prevent a chain-reaction collision from occurring by safely braking a vehicle behind a target vehicle because changed speed information is shared with the vehicle behind when sudden deceleration, a sudden stop, or an abnormal stop occurs, and can improve a driving decision time and a traffic jam because a lane change of a vehicle behind can be supported according to a situation.

Furthermore, the electronic device 100 according to an embodiment may be further advantageous in solving a traffic jam because vehicles can be dynamically adapted according to a traffic flow by separating or integrating a group based on route information, a traffic signal, or a lane change.

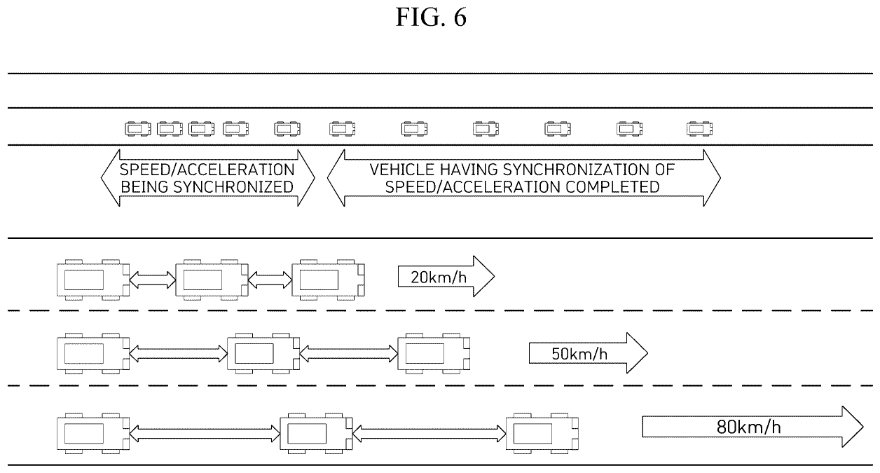

Hereinafter, constructing a group according to an embodiment is described in detail with reference to FIGS. 5 to 9.

FIGS. 5 and 6 are examples in which the speeds of vehicles are synchronized according to an embodiment. FIGS. 7 and 8 are examples in which vehicle groups are integrated or separated according to an embodiment.

Referring to FIG. 5, the electronic device 100 (e.g., the processor 130 in FIG. 4) according to an embodiment may construct a plurality of groups G1 to G8 by grouping vehicles placed in the same lane.

According to an embodiment, the electronic device 100 may receive a speed and acceleration from a leading vehicle for each group, and may provide the corresponding speeds and acceleration to all of the corresponding groups. As a result, for example, “Group 1 (G1)” may be synchronized with speed information including “speed of 0 km/h and acceleration of 0 m/s2”. “Group 4 (G4) ” may be synchronized with speed information including “speed of 40 km/h and acceleration of 10m/s2 ”.

Referring to FIG. 6, vehicles (e.g., 200_1 to N in FIG. 3) within each group may travel by being synchronized with a speed/acceleration that is provided by the electronic device 100 in the state in which a safety distance between the vehicles has been secured as the second designated distance. Accordingly, the synchronized vehicles within the group may travel by being synchronized with the speed of a leading vehicle in the state the safety distance has been secured. For example, vehicles within a first lane group may travel by being synchronized with the speed of 20 km/h based on the speed of a leading vehicle. Vehicles within a second lane group may travel by being synchronized with the speed of 50 km/h based on the speed of a leading vehicle. Vehicles within a third lane group may travel by being synchronized with the speed of 80 km/h based on the speed of a leading vehicle.

Referring to FIGS. 7 and 8, when a leading vehicle of a group that has already been constructed based on vehicle location information is present or vehicles (e.g., 720) of a group ahead of a target vehicle 710 that has been newly confirmed are present, the electronic device 100 according to an embodiment may determine a group of the target vehicle 710 based on an interval between the target vehicle 710 and the last vehicle (the latest turn vehicle) 720 of the preceding group.

As illustrated in FIG. 7, for example, when an interval (d) between the target vehicle 710 and the latest turn vehicle 720 of the preceding group is less than a first designated distance (th1), the electronic device 100 may include the target vehicle 710 in the preceding group.

In contrast, as illustrated in FIG. 8, for example, when the interval (d) between the target vehicle 710 and the latest turn vehicle 720 of the preceding group is equal to or greater than the first designated distance (th1), the electronic device 100 does not include the target vehicle 710 in the preceding group 730, and may construct a new group 740 by using the target vehicle 710 as a leading vehicle when a vehicle behind the target vehicle 710 is present.

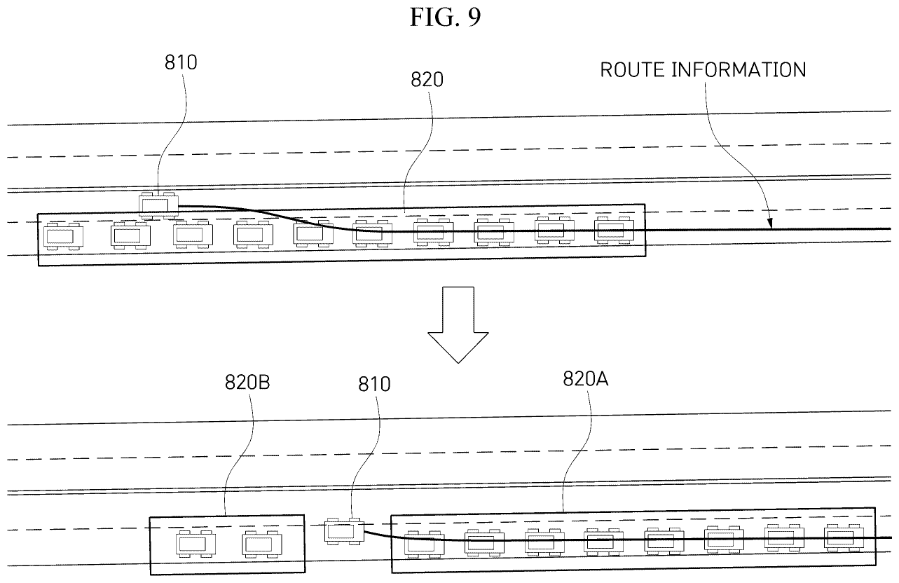

FIG. 9 is an example in which a group is controlled in a lane change situation according to an embodiment.

Referring to FIG. 9, according to an embodiment, a first vehicle 810 may confirm that a lane change is required based on route information, and may transmit, to the electronic device 100, a lane change request for another lane.

According to an embodiment, when obtaining the lane change request, the electronic device 100 may check whether another group is present in another lane. When another group 820 is present, the electronic device 100 may provide (e.g., transmit) to a deceleration request to vehicles 820B behind the first vehicle 810 within the checked another group 820. In response to the deceleration request, the vehicles behind 820B within the another group are decelerated. The first vehicle 810 may cut into a space that is formed due to the deceleration of the vehicles behind 820B.

According to an embodiment, the electronic device 100 may provide vehicles 820A ahead of the first vehicle 810 with an acceleration request. The vehicle 820A ahead the first vehicle 810 within another group may be accelerated in response to the acceleration request, and thus a space into the first vehicle 810 can cut can be formed faster. In relation thereto, the electronic device 100 may check an interval between a leading vehicle of the another group 820 and a vehicle ahead thereof, and may determine whether to make an acceleration request.

As described above, the electronic device 100 according to an embodiment may provide a space into which a related vehicle can cut to the vehicle or support joining to another group, when a lane change is performed based on a driving route or the occurrence of an accident.

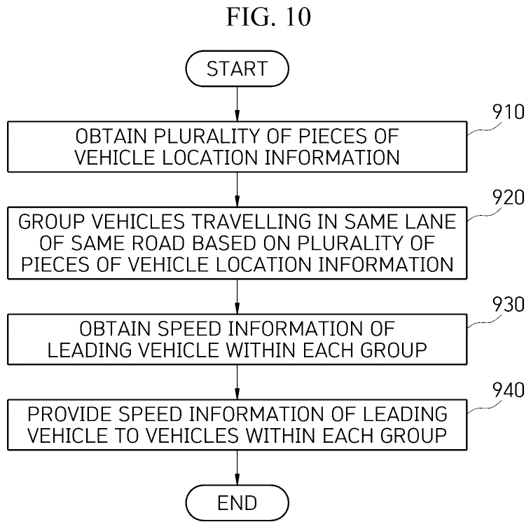

FIG. 10 is a flowchart of a method of synchronizing the speeds of vehicles according to an embodiment.

Referring to FIG. 10, in operation 910, the electronic device 100 may obtain a plurality of pieces of vehicle location information from a plurality of vehicles through V2X communication. The vehicle location information may include vehicle identification information, a vehicle location coordinate value, a link ID, and a lane number.

In operation 920, the electronic device 100 may group vehicles that are travelling in the same lane of the same road, among the plurality of vehicles, based on the plurality of pieces of vehicle location information. For example, the electronic device 100 may confirm a vehicle that is travelling in the same lane of the same road based on the link ID and the lane number included in the vehicle location information.

In operation 930, the electronic device 100 may obtain speed information of a leading vehicle from each group. The electronic device 100 may confirm the leading vehicle based on the location coordinate value included in the vehicle location information, and may obtain the speed information of the leading vehicle by requesting the speed information from the leading vehicle. The speed information may include at least piece of information, among a speed, acceleration, an accelerator state, and a brake state.

In operation 940, the electronic device 100 may provide the speed information of the leading vehicle to vehicles within each group so that speed control over the vehicles within each group is synchronized. Thereafter, vehicles (e.g., 200_1 to 200 N in FIG. 3) belonging to the same group may each control their accelerators and acceleration pedals, ensuring that their speed and acceleration align with those of the leading vehicle, while maintaining a safety distance of at the second designated distance or more from the vehicle ahead.

As described above, the electronic device 100 according to an embodiment groups and manages vehicles that are travelling in the same lane. Accordingly, a problem that adds a traffic jam because vehicle drivers are unaware of a vehicle control form of another driver can be solved because vehicles within group are supported so that the vehicles are synchronized and travel like a train while maintain the same speed and same safety distance.

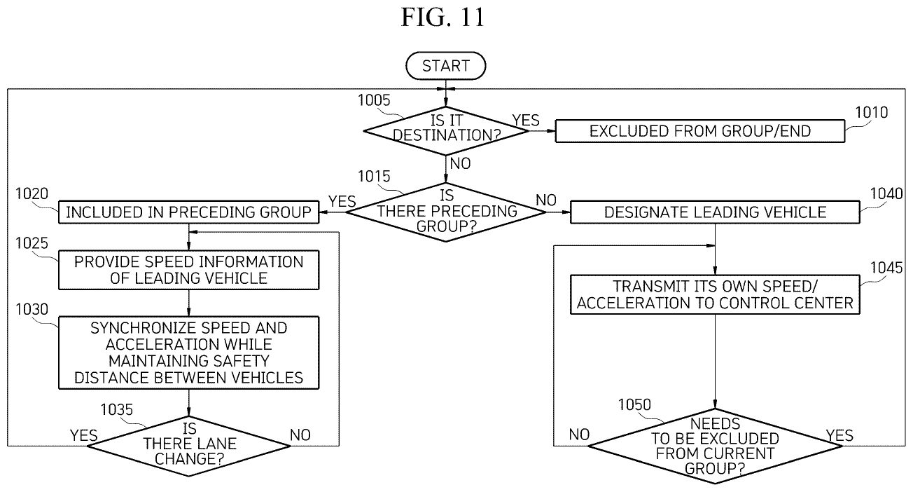

FIG. 11 is a detailed flowchart of a method of synchronizing the speeds of vehicles according to an embodiment.

Referring to FIG. 11, when confirming a lane change of a target vehicle based on vehicle location information, the electronic device 100 may confirm whether the target vehicle has arrived at a destination in operation 1005. The electronic device may confirm whether the target vehicle has arrived at the destination based on route information of the target vehicle. When confirming that the target vehicle has arrived at the destination, the electronic device 100 may exclude the target vehicle arrived at the destination from the existing group in operation 1010.

When confirming that the target vehicle is in the state in which the target vehicle has not arrived at the destination in operation 1005, the electronic device 100 may confirm whether there is a preceding group ahead of the target vehicle in operation 1015.

When the electronic device 100 confirms that there is a preceding group ahead of the target vehicle in operation 1015, the electronic device 100 may include the target vehicle in the preceding group in operation 1020.

In operation 1025, the electronic device 100 may provide speed information of the leading vehicle to the target vehicle. In response thereto, in operation 1030, the target vehicle may synchronize its speed and acceleration with the speed and acceleration of the leading vehicle while maintaining a safety distance from a vehicle ahead thereof at the second designated distance or more.

In operation 1035, when a route (e. g., a lane) of the target vehicle is changed based on route information, the electronic device 100 may perform operation 1005.

When the electronic device 100 confirms that there is no preceding group ahead of the target vehicle in operation 1015, the electronic device 100 may designate the target vehicle as a leading vehicle of a new group in operation 1040, and may transmit a speed information request from the target vehicle. Accordingly, the electronic device 100 may change and assign the turn of a vehicle behind the target vehicle.

In operation 1045, in response thereto, the target vehicle may transmit its speed information to the electronic device 100. The electronic device 100 may obtain the speed information of the target vehicle. The electronic device 100 may share the speed information of the target vehicle with vehicles within the new group.

In operation 1050, when the target device arrives at the destination, the target device may transmit a group withdrawal request (or route information) to the electronic device 100. In response thereto, the electronic device 100 may receive the group withdrawal request and perform the route operation 1005 in response thereto.

As described above, the electronic device 100 according to an embodiment can dynamically manage a group for speed synchronization depending on various conditions, such as a lane change of a vehicle, whether a destination has been reached, whether another group is present within a driving lane (or roadway), and whether a leading vehicle is present.

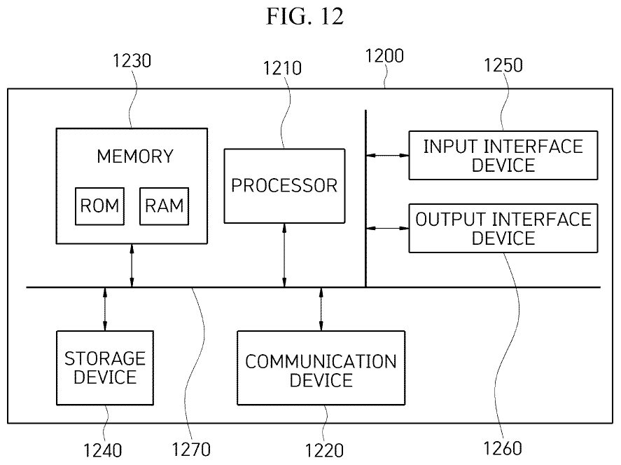

FIG. 12 is a construction diagram illustrating a vehicle system for embodying a speed sharing method according to an embodiment.

Referring to FIG. 12, a vehicle system 1200 (e. g., the vehicle 200_1 in FIG. 3) may include at least one of a processor 1210, memory 1230, an input interface device 1250, an output interface device 1260, and a storage device 1240, which perform communication through a bus 1270. The computer system 1200 may further include a communication device 1220 that is connected to a network. The processor 1210 may be a central processing unit (CPU) or may be a semiconductor device that executes command stored in the memory 1230 or the storage device 1240. The memory 1230 and the storage device 1240 may include various forms of volatile or nonvolatile storage media. For example, the memory may include read only memory (ROM) and random access memory (RAM). In an embodiment of this specification, the memory may be disposed inside or outside the processor. The memory may be connected to the processor through various already-known means. The memory may be various forms of volatile or nonvolatile storage media. For example, the memory may include read-only memory (ROM) or random access memory (RAM).

Various embodiments of this document and terms used in the embodiments are not intended to limit the technical characteristics, described in this document, to specific embodiments, and should be understood as including various changes, equivalents or alternatives of a corresponding embodiment. In relation to the description of the drawings, similar reference numerals may be used for similar or related components. A singular form of a noun corresponding to an item may include one item or a plurality of items unless explicitly described otherwise in the context. In this document, each of phrases, such as “A or B”, “at least one of A and B”, “at least one of A or B”, “A, B or C”, “at least one of A, B, and C”, and “at least one of A, B, or C”, may include any one of items listed along with a corresponding one of the phrases or all possible combinations of the listed items. Terms, such as “a first”, “a second”, or “the first” or “the second”, may be used to merely distinguish between a corresponding component and another corresponding component, and do not limit corresponding components in another aspect (e.g., importance or a sequence). If any (e.g., a first) component is described as being “coupled” or “connected” to another (e. g., a second) component along with a term “functionally” or “communicatively” or without such a term, this means that the any component may be coupled to the another component directly (e. g., in a wired way), wirelessly, or through a third component.

The term “module” used in various embodiments of this document may include a unit implemented as hardware, software or firmware, and may be interchangeably used with a term, such as logic, a logical block, a part, or a circuit. The module may be an integrated part, or a minimum unit of the part or a part thereof, which performs one or more functions. For example, according to an embodiment, the module may be implemented in the form of an application-specific integrated circuit (ASIC).

Various embodiments of this document may be embodied as software (e.g., a program) including one or more instructions stored in a storage medium (e.g., the memory 120 in FIG. 4) (e.g., embedded memory or external memory) readable by a machine (e. g., an electronic device). For example, a processor (e.g., the processor 130) of a device (e.g., the electronic device 120) may invoke at least one of the one or more instructions stored in the storage medium, and may execute the instruction. This enables the machine to operate to perform at least one function based on the invoked at least one instruction. The one or more instructions may include a code generated by a complier or a code executable by an interpreter. The machine-readable storage media may be provided in the form of a non-transitory storage medium. In this case, “non-transitory” merely means that the storage medium is a tangible device and does not include a signal (e.g., electromagnetic wave). The term does not distinguish between a case where data is semi-permanently stored in the storage medium and a case where data is temporally stored in the storage medium.

According to an embodiment, the method according to various embodiments disclosed in this document may be included in a computer program product and provided. The computer program product may be traded as a product between a seller and a purchaser. The computer program product may be distributed in the form of a machine-readable storage medium (e.g., a compact disc read only memory (CD-ROM) ) or may be distributed through app store (e.g., PlayStore™) or directly between two user devices (e.g., smartphones) or online (e. g., download or upload). In the case of the online distribution, at least some of the computer program products may be at least temporarily stored or provisionally generated in a machine-readable storage medium, such as the memory of the server of a manufacturer, the server of an app store or a relay server.

The components according to various embodiments of the present disclosure may be implemented in the form of software or hardware, such as a digital signal processor (DSP), a field programmable gate array (FPGA) or an application-specific integrated circuit (ASIC), and may perform given roles. The “components” are not components having meanings limited to software or hardware, and each component may be configured to reside on an addressable storage medium and may be configured to operate one or more processors. For example, the component may include components, such as software components, object-oriented software components, class components, and task components, processes, functions, attributes, procedures, sub-routines, segments of a program code, drivers, firmware, a microcode, circuitry, data, a database, data structures, tables, arrays, and variables.

According to various embodiments, each (e. g., a module or a program) of the aforementioned components may include a single entity or a plurality of entities. According to various embodiments, one or more components or operations of the aforementioned components may be omitted or one or more other components or operations may be added. Alternatively or additionally, a plurality of components (e.g., modules or programs) may be integrated into a single component. In such a case, the integrated component may identically or similarly perform a function performed by a corresponding one of the plurality of components before one or more functions of each of the plurality of components are integrated. According to various embodiments, operations performed by a module, a program, or another component may be executed sequentially, in parallel, iteratively or heuristically, or one or more of the operations may be executed in different order or may be omitted, or one or more other operations may be added.

1. An electronic device comprising:
a communication module configured to provide a communication channel for a plurality of vehicles; and
a processor functionally connected to the communication module,
wherein the processor
obtains a plurality of pieces of vehicle location information from the plurality of vehicles through the communication module,
groups vehicles travelling in an identical lane of an identical road, among the plurality of vehicles, based on the plurality of pieces of vehicle location information,
obtains speed information of a leading vehicle within each group through the communication module, and
provides the speed information of the leading vehicle to vehicles within each group through the communication module so that speed control over the vehicles within each group is synchronized.

2. The electronic device of claim 1, wherein:
the vehicle location information comprises a link ID and lane number of a road on which each vehicle is travelling, and
the processor groups vehicles having an identical link ID and lane number.

3. The electronic device of claim 1, wherein the processor
further obtains traffic information from the leading vehicle, and
provides the traffic information to the vehicles within each group.

4. The electronic device of claim 1, wherein the obtained speed information of the leading vehicle comprises at least piece of information, among a speed, acceleration, accelerator state, and brake state of the leading vehicle.

5. The electronic device of claim 1, wherein the processor constructs a group by integrating or Separating the group based on an interval between the leading vehicle and a last vehicle of another group ahead of the leading vehicle when vehicles of the another group are present.

6. The electronic device of claim 1, wherein the processor confirms whether there is a vehicle behind, which complies with a designated condition in which a change in a speed within each group corresponds to a sudden change in a speed, based on the plurality of pieces of vehicle location information, and
provides speed information of the vehicle behind to a vehicle behind the vehicle behind that complies with the designated condition.

7. The electronic device of claim 1, wherein the processor provides a lane change request attributable to an occurrence of an accident to a vehicle behind an abnormal stop vehicle, among the vehicles within each group, when confirming the abnormal stop vehicle based on the plurality of pieces of vehicle location information.

8. The electronic device of claim 1, wherein the processor
confirms whether another group is present in another lane when obtaining lane change request from at least one vehicle within each group to the another lane through the communication module, and
provides a speed adjustment request to vehicles behind the at least one vehicle within the confirmed another group.

9. The electronic device of claim 1, wherein when confirming a vehicle having a driving road and lane different from a driving road and lane of other vehicles or a vehicle attempting to change a lane, among the vehicles within each group, based on the plurality of pieces of vehicle location information, the processor excludes the confirmed vehicle from a corresponding group.

10. A method of synchronizing speeds of vehicles by an electronic device, the method comprising:
an operation of obtaining a plurality of pieces of vehicle location information from a plurality of vehicles;
an operation of grouping vehicles that are travelling in an identical lane of an identical road, among the plurality of vehicles, based on the plurality of pieces of vehicle location information;
an operation of obtaining speed information of a leading vehicle in each group; and
an operation of providing the speed information of the leading vehicle to vehicles within each group so that speed control over the vehicles within each group is synchronized.
